(19) United States
(12) Patent Application Publication
(10) Pub. No.: US 2023/0175952 A1
(43) Pub. Date: Jun. 8, 2023

(54) Uniaxial Optical Multi-Measurement Sensor

(71) Applicant: Utah State University Space Dynamics Laboratory, North Logan, UT (US)

(72) Inventor: Aaron Pung, Albuquerque, NM (US)

(73) Assignee: Utah State University Space Dynamics Laboratory, North Logan, UT (US)

(21) Appl. No.: 17/540,327

(22) Filed: Dec. 2, 2021

(51) Int. Cl. G01N 21/21; G01J 4/04

(52) U.S. Cl. CPC G01N 21/21; G01J 4/04; G01N 2021/1772

(57) ABSTRACT

In embodiments, a uniaxial optical multi-measurement sensor comprises a sensor housing having a center axis and a cylindrical surface and an array of electrically coupled light-sensitive pixel elements attached to the cylindrical surface. Each pixel element is positioned having its light-sensitive side facing towards the center axis. In this embodiment, a conical light redistribution optic is positioned along the center axis to direct or reimage uncollimated light entering the sensor housing onto the pixel elements. Also, in this embodiment, the pixel elements are positioned relative to the light redistribution optic to measure or image two or more properties of the uncollimated light entering the sensor housing of a single scene and from a single viewpoint.

### TECHNICAL FIELD

The present disclosure relates to measuring properties of light from a scene, and more particularly, to novel systems and methods for measuring multiple properties of light from a single sensor.

### BACKGROUND

Optical sensors are used to capture or measure different properties of light, across a variety of wavelengths. A hyperspectral optical system may record thousands of different images for a single scene, each image capturing a different wavelength, with the purpose of finding objects, identifying materials, or detecting processes. Additionally, a polarimeter may be used for determining the polarization direction of light or the rotation of an optically active substance.

Multiple optical sensors may be used to view, capture, or simultaneously measure (or near simultaneously) multiple properties of light from a single scene. While the multiple sensors may be looking at the same scene and measuring multiple light properties propagating from the scene, they do so from different viewpoints because each optical sensor is a separate sensor with its own optical system and sensor arrays. This is true regardless of how close the multiple optical systems are placed next to each other.

### SUMMARY

The inventor of the embodiments described in this disclosure has identified the need for simultaneously measuring multiple properties of light of a scene from a single viewpoint. The present disclosure in aspects and embodiments addresses these various needs and problems. It is an object of the present invention to simultaneously measure multiple properties of light of a scene from a single viewpoint.

FIG. 1 is a prior-art figure illustrating multiple optical sensors 140, 141, and 142 viewing a scene 130 from multiple viewpoints. What is occurring in the scene 130 is not significant, only that light is propagating from the scene 130. In this depiction, different properties of light 92, 93, and 94, propagate from the scene 130 to three distinct optical sensors 140, 141, and 142. In reality, all properties of light 92, 93, and 94 propagate from the scene to each of the three optical sensors 140, 141, and 142 but each of the three optical sensors 140, 141, and 142 are designed to detect or measure only one property light. Additionally, each of the three optical sensors 140, 141, and 142 detect or measure their respective property of light from a different viewpoint with respect to the other two optical sensors.

In contrast to FIG. 1, FIG. 2 illustrates a sensor system 100 that simultaneously detects, measures, or images two or more properties of light emitted or reflected from the scene 130 from a single viewpoint.

Additionally, the inventor of the present disclosure has noted that traditional cameras with a square-shaped pixel array have a limited pixel-array area. Additional pixels may be placed on a cylindrical housing of a camera by using a conical light redistribution optic to direct or reimage uncollimated light entering the cylindrical housing onto the pixel elements. It is also an object of the present invention to increase the available area of a pixel array by placing a pixel array on a cylindrical housing.

FIG. 3 illustrates a prior-art figure of a traditional camera configuration with a square-shaped pixel array 23 at the back of a camera housing 9. The width of the pixel array 23 in this illustration is w and the radius of the camera housing is r. Assuming the square pixel array 23 fills the maximum area of the housing 9, the area of the pixel array is w² or 2r² (following the Pythagorean theorem: (2r)²=w²+w²; therefore, 4r²=2w²; w=sqrt(2)*r; and w²=2r²).

FIG. 4 illustrates a sensor housing 10 that forms part of an embodiment of a uniaxial optical multi-measurement sensor described herein. Sensor housing 10 has a depth h and includes an array 24 of electrically coupled light-sensitive pixel elements 26 attached to the sensor housing's cylindrical surface 10A. Each pixel element 26 is positioned having its light-sensitive side facing towards a center axis 80. The area of the cylindrical surface 10A is 2πrh, where r is the radius of the cylindrical housing 10 and h is the height or depth of the cylindrical housing 10. Assuming r is the same between the sensor housing 9 in FIG. 3 and sensor housing 10 in FIG. 4, the ratio of cylindrical surface 10A to the square-shaped pixel array 23 at the back of a camera housing 9 (in FIG. 3) is πh/r. Therefore, if h is as large as r, then the area of cylindrical surface 10A is at least Tr times more than the area of the square pixel array 23. Thus, more pixels may be placed on cylindrical surface 10A than on the back end of a traditional camera housing 9.

Placing pixels on cylindrical surface 10A requires that light entering the housing 10 be directed towards those pixels. Light may be directed towards pixel elements 26 by using a conical light redistribution optic to direct or reimage uncollimated light entering the cylindrical housing 10 onto the pixel elements 26, as is described in more detail, below.

In embodiments, a sensor system comprises a sensor housing having a center axis and a cylindrical surface and an array of electrically coupled light-sensitive pixel elements attached to the cylindrical surface. Each pixel element is positioned having its light-sensitive side facing towards the center axis. In this embodiment, a conical light redistribution optic is positioned along the center axis to direct or reimage uncollimated light entering the sensor housing onto the pixel elements. Also, in this embodiment, the pixel elements are positioned relative to the light redistribution optic to measure or image two or more properties of the uncollimated light entering the sensor housing of a single scene and from a single viewpoint.

In another embodiment, the sensor system further comprises an end surface at the end of the sensor housing and a second array of electrically coupled light-sensitive pixel elements attached to the end surface.

In another embodiment, the uncollimated light entering the sensor housing is reflected from the conical light redistribution optic to the array of electrically coupled light-sensitive pixel elements attached to the cylindrical surface and transmitted through the conical light redistribution optic towards the second array of pixel elements attached to the end surface.

In another embodiment, the end surface at the end of the sensor housing is a hemispherical dome.

In another embodiment, the conical light redistribution optic further comprises a first outside surface defined by a first angle relative to the center axis and a second outside surface defined by a second angle relative to the center axis, the second angle being greater than the first angle.

In another embodiment, the conical light redistribution optic further comprises a spacer section that separates, in a direction along the center axis, portions of the conical light redistribution optic outside surface to form two or more light redistribution optic sections.

In another embodiment, the conical light redistribution optic is a conical beam splitter.

In another embodiment, the conical light redistribution optic is two or more conical light redistribution optics stacked along the center axis to direct or reimage the uncollimated light entering the sensor housing onto the pixel elements.

In another embodiment, one of the two or more conical light redistribution optics stacked along the center axis is a lensed conical light redistribution optic and the other of the two or more light redistribution optics stacked along the center axis is a non-lensed conical light redistribution optic.

Embodiments of the present disclosure also include methods for measuring or imaging from a single viewpoint two or more properties of light entering a sensor system from a single scene, the sensor system.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a prior-art depiction of multiple optical sensors viewing a scene from multiple viewpoints;

FIG. 2 is a depiction of an embodiment of the present disclosure capturing or measuring multiple properties of light from a single viewpoint;

FIG. 3 is a prior-art view of a traditional camera system;

FIG. 4 is a perspective view of a sensor housing;

FIGS. 5A and 5B are a perspective and side view, respectively, of an embodiment of the present disclosure;

FIGS. 6A-6D are other perspective views of various sensor housings;

FIGS. 7A and 7B are other cut-away perspective views of other sensor housings;

FIGS. 8A-8C are perspective views of portions of an embodiment of the present disclosure;

FIGS. 9A-9H illustrate various light redistribution optics;

FIGS. 10A-10C are perspective views of various embodiments of the present disclosure;

FIGS. 11A, 11B, 12A-12D, and 13 illustrate simulated ray traces of various embodiments of the present disclosure;

FIG. 14A illustrates an original image of a scene;

FIGS. 14B-14E illustrate an image reconstruction of the original scene in FIG. 14A from various embodiments of the present disclosure;

FIG. 15 illustrates a simulated ray trace of another embodiment of the present disclosure;

FIG. 16 is a graph illustrating the reflectivity of two coatings applied to the embodiment illustrated in FIG. 15; and

FIG. 17 illustrates a method embodiment of the claimed invention.

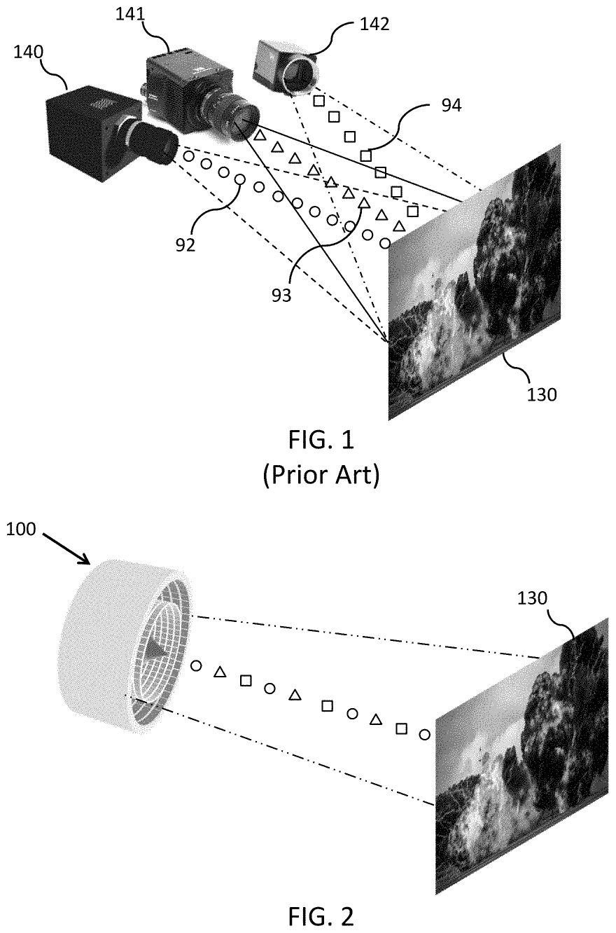

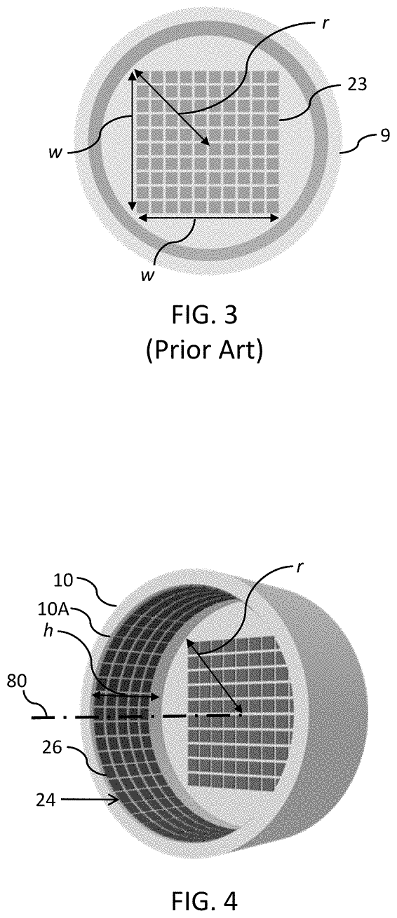

### DETAILED DESCRIPTION

The present disclosure covers apparatuses and associated methods for a sensor system with a pixel array attached to a cylindrical surface. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional”, “optionally” or “or” refer, for example, to instances in which subsequently described circumstance may or may not occur, and include instances in which the circumstance occurs and instances in which the circumstance does not occur. For example, if the text reads “option A or option B,” there may be instances where option A and option B are mutually exclusive or instances where both option A and option B may be included. The terms “one or more” and “at least one” refer, for example, to instances in which one of the subsequently described circumstances occurs, and to instances in which more than one of the subsequently described circumstances occurs.

The following examples are illustrative only and are not intended to limit the disclosure in any way.

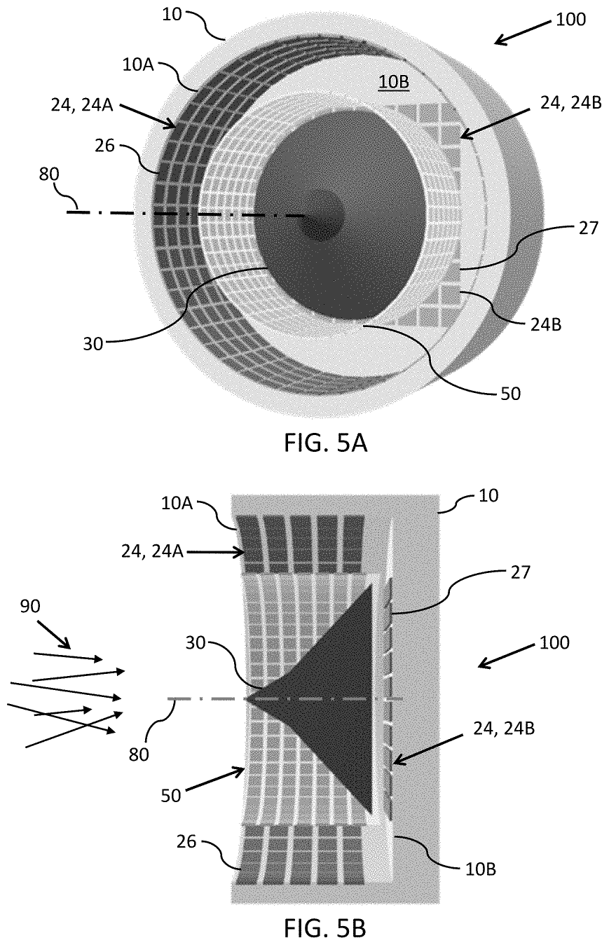

FIG. 5A is an isometric view and FIG. 5B is a cross-section side view of a sensor system 100, which is an embodiment of the present invention. The sensor system 100 includes a housing 10, an array of electrically coupled light-sensitive pixel elements or pixel array 24 (e.g., 24A and 24B), a transmissive filter 50, and a light redistribution optic 30. The same components of the sensor system 100 may be shaded differently between FIGS. 5A and 5B (and other FIGS. referenced herein) such that components may be better seen when the drawings are reproduced.

In this example, the housing 10 is a capped cylinder shape with a center axis 80, a cylindrical surface 10A (e.g., the inside surface of cylindrical housing 10), and an end-face surface 10B. In this embodiment, the pixel array 24A is attached to the cylindrical surface 10A and the pixel array 24B is attached to the end-face 10B. In this depiction, pixel array 24A comprises pixel elements 26 and pixel array 24B comprises pixel elements 27. In this embodiment, each pixel element 26 has a light-sensitive side facing towards the center axis 80. Additionally, each pixel element 27 has a light-sensitive side facing along the center axis 80. Pixel elements 26 and 27 are positioned such that each pixel element 26 and 27 is able to absorb or detect light 90 (illustrated in FIG. 5B) entering the sensors system 100 or housing 10.

In this example, the light 90 is depicted as various random vectors in FIG. 5B. The light 90 entering the sensor system 100 may be collimated or uncollimated, travelling parallel to the center axis 80 or non-parallel to the center axis 80, and propagating in an open or encapsulated medium. In the depicted example, light 90 is directed into the sensor housing 10 where it encounters the light redistribution optic 30 and is redirected towards the pixel array 24A or transmitted through the light redistribution optic 30 towards the pixel array 24B.

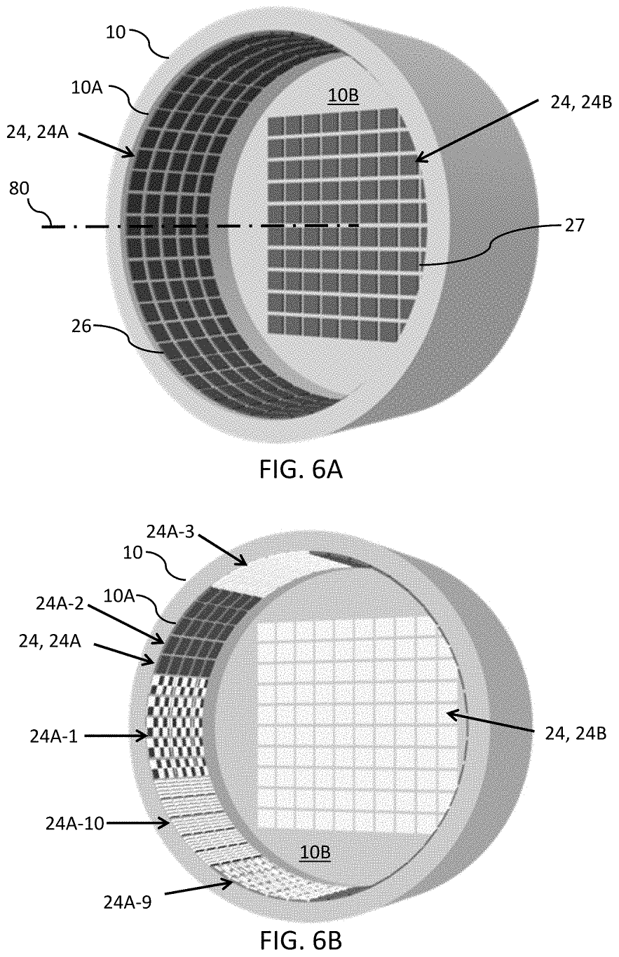

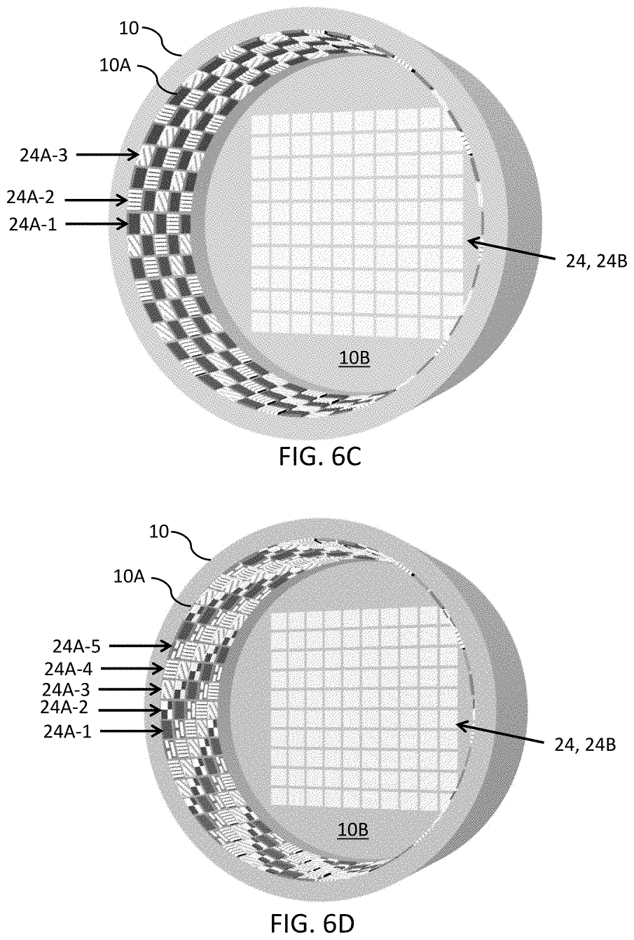

FIGS. 6A through 6D illustrate various embodiments or arrangements of pixel array 24A shown on a cylindrical housing 10.

FIG. 6A illustrates a cylindrical sensor housing 10 with cylindrical surface 10A and an end-face surface 10B, similar to what is shown in FIGS. 4, 5A, and 5B. The pixel array 24A is attached to the cylindrical surface 10A and the pixel array 24B is attached to the end-face 10B. Pixel elements 26 in pixel array 24A are positioned having their light-sensitive sides facing towards the center axis 80. Pixel elements 27 in pixel array 24B are positioned having their light-sensitive sides facing along the center axis 80. In this and other depictions, pixel array 24B is shown in a square pattern for simplicity. Other pixel array patterns may be used based on the available area of the end-face surface 10B.

FIG. 6B illustrates groups of pixel elements arranged into two or more groups of sub-sensors 24A-1-24A-10. Sub sensors 24A-4-24A-8 are not labeled as their view is obscured by the isometric view of cylindrical housing 10. More or fewer sub-senor groups are possible depending on the purpose or intended functionality of a uniaxial optical multi-measurement sensor employing two or more groups of sub-sensors. The various patterns illustrated on the different groups of sub-sensors are for illustration purposes and are only intended to show where one sub-sensor begins and another sub-sensor ends on the surface, in this example, surface 10A.

In embodiments, each sub-sensor group 24A-N (e.g., 24A-1-24A-10) may be configured to measure or image a different property of the light entering the sensor housing 10. For example, a sub-sensor group may be configured to provide any one of imaging, intensity analysis, spectral analysis, polarization analysis, signal detection, distance, displacement, time-of-flight, or direction-of-arrival signals from the light entering the sensor housing 10. Imaging may be performed in various wavelength regimes, for example, infrared, visible, ultraviolet, or any collection of these spectral bands, for example, in multispectral or hyperspectral imagery. Alternatively or additionally, sub-sensor groups may be repeated on different portions of the sensor housing surface. For example, there may be multiple sub-sensor groups provided for imaging (e.g., imaging in a single or different wavelengths) or other light measurement analysis described above.

FIG. 6C also illustrates pixel array 24B on the back surface 10B. In these figures, pixel array 24B does not show different patterns, however, pixel array 24B may be similarly divided up into two or more groups of sub-sensors or may be a single sub sensor configured to measure or capture only one property of light entering the sensor housing 10. FIG. 6C illustrates an alternative way to arrange two or more groups of sub-sensors 24A-1-24A-3. Like other embodiments, more or fewer sub-senor groups are possible depending on the purpose or intended functionality of a uniaxial optical multi-measurement sensor employing two or more groups of sub-sensors. Additionally, the various patterns illustrated on the different groups of sub-sensors are for illustration purposes and are only intended to show where one sub-sensor (or pixel) begins and another sub-sensor (or pixel) ends on the surface, in this example, surface 10A.

FIG. 6D illustrates yet another way to arrange two or more groups of sub-sensors 24A-1-24A-5. Like other embodiments, more or fewer sub-senor groups are possible depending on the purpose or intended functionality of a uniaxial optical multi-measurement sensor employing two or more groups of sub-sensors. Additionally, the various patterns illustrated on the different groups of sub-sensors are for illustration purposes and are only intended to show where one sub-sensor (or pixel) begins and another sub-sensor (or pixel) ends on the surface, in this example, surface 10A.

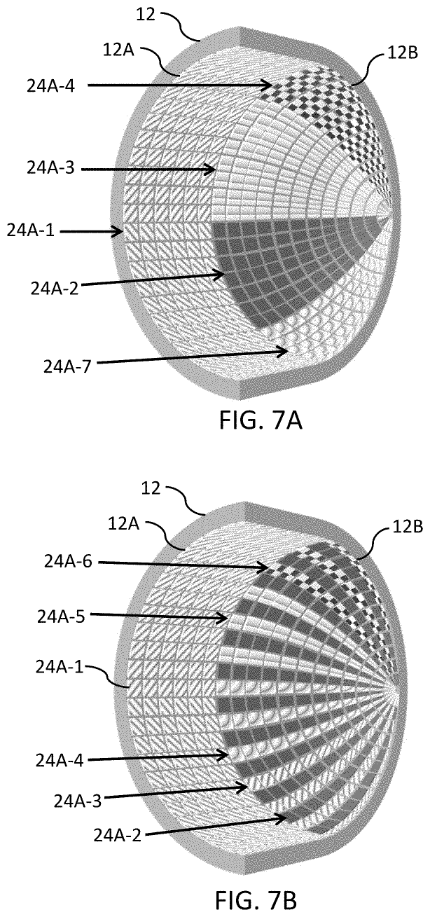

FIG. 7A illustrates a cut-away view of a dome-sensor housing 12 with another arrangement of sub-sensors 24A-1 through 24A-7. Sub sensors 24A-5 and 24A-6 are not labeled as their view is cut out from the isometric view of cylindrical housing 12. Sub-sensor 24A-1 is located on the cylindrical surface 12A of dome-sensor housing 12 and all other sub-sensors are located on the dome portion 12B of dome-sensor housing 12.

Similarly, FIG. 7B illustrates another cut-away view of a dome-sensor housing 12 with another arrangement of sub-sensors 24A-1 through 24A-6.

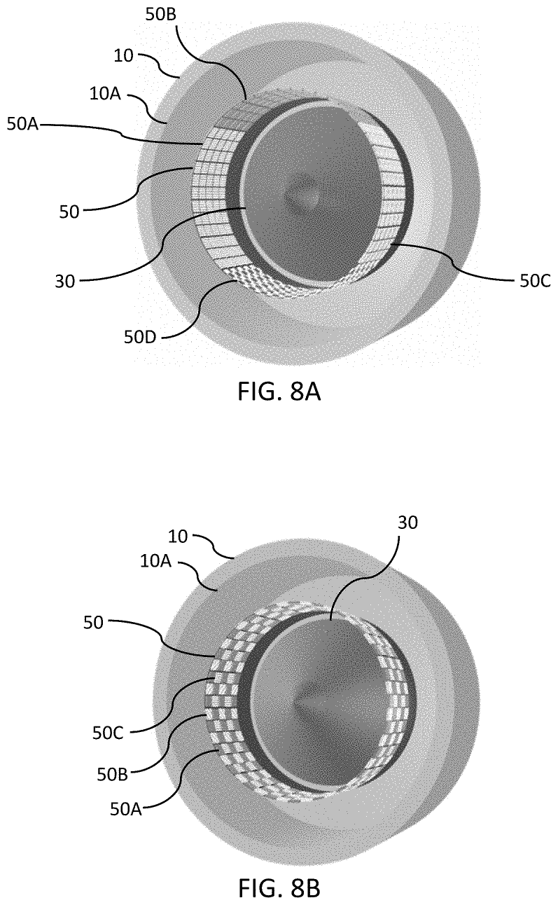

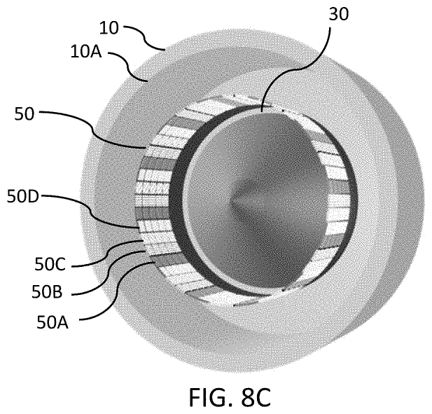

FIGS. 8A through 8C illustrate various embodiments of transmissive filters positioned between pixel elements (which are not shown in these figures for clarity but would be located on housing surface 10A) and the light redistribution optic 30. Transmissive filters include spectral filters (ex. notch, bandpass, edgepass, laser line), polarimetric filters (ex. wire grid, film, Brewster window), and neutral density filters. Transmissive filter 50 may be subdivided into different types of transmissive filters based on the type of measurement or light property a pixel or sub-sensor, e.g., sub-sensors 24A-N in previous figures, is supposed to detect, measure, or image. In this example, transmissive filter 50 is divided into four sub-filters 50A-50D. More or fewer sub-filters may be added or subtracted to embodiments based on the intended functionality of a uniaxial optical multi-measurement sensor.

A transmissive filter 50 may be positioned between the light redistribution optic 30 and pixel array 24A (shown in previous figures). In embodiments, the transmissive filter 50 may be a separate component physically located in the light path between the light redistribution optic 30 and pixel array 24A, as illustrated in FIGS. 6A through 6C. In other embodiments, the transmissive filter 50 may be placed on the face of the pixel array 24A or on the face of the light redistribution optic 30, in which case the transmissive filter is still placed between the light redistribution optic 30 and the pixel array 24A.

In FIGS. 8A-8C, the various patterns illustrated on the different groups of transmissive filters (e.g., 50A-50D) are for illustration purposes and are only intended to show where one type of transmissive filter begins and another type of transmissive filter ends. For example, FIGS. 8B and 8C illustrate alternative transmissive filter arrangements. FIG. 8B illustrates various transmissive filter elements 50A, 50B, and 50C, arranged in a checker-board pattern. FIG. 8C illustrates the various transmissive filter elements 50A, 50B, and 50C arranged in bands. The specific types of filters and their arrangement depends on the intended functionality of a uniaxial optical multi-measurement sensor and its pixels or sub-sensors (e.g., sub-sensors 24A-N).

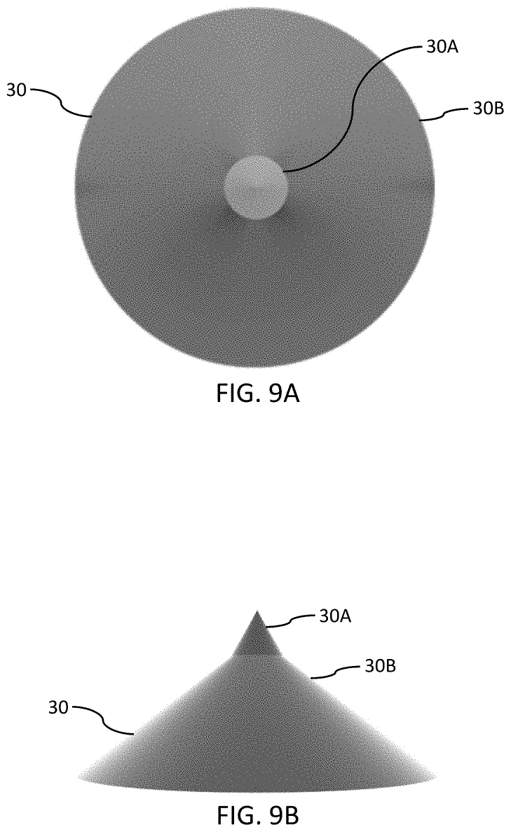

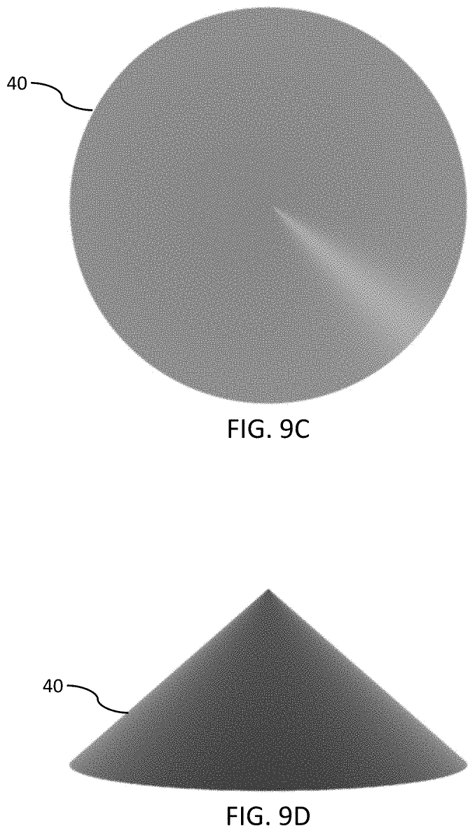

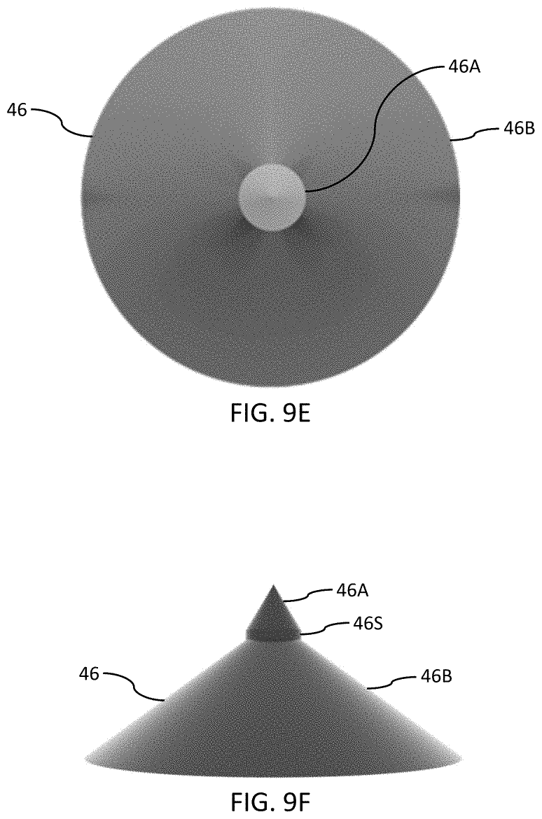

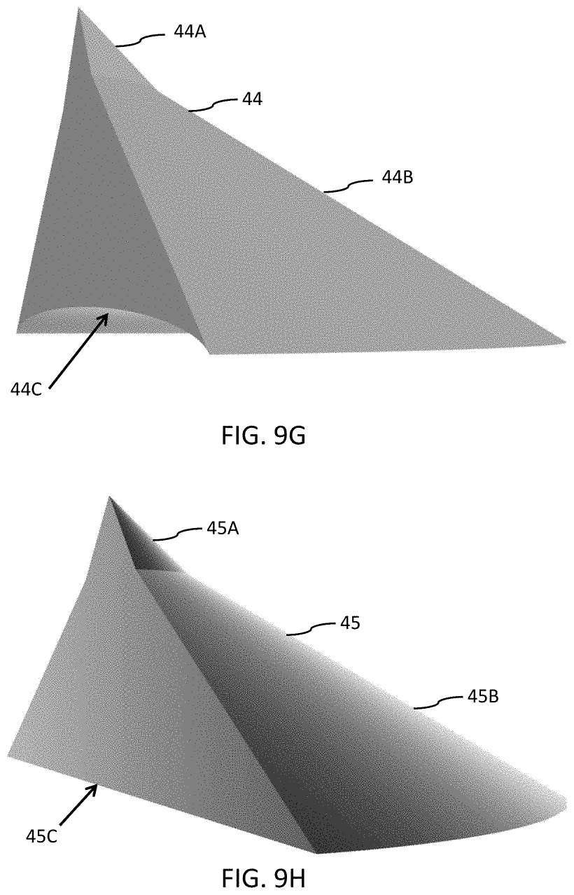

FIGS. 9A through 9H illustrate various light redistribution optics.

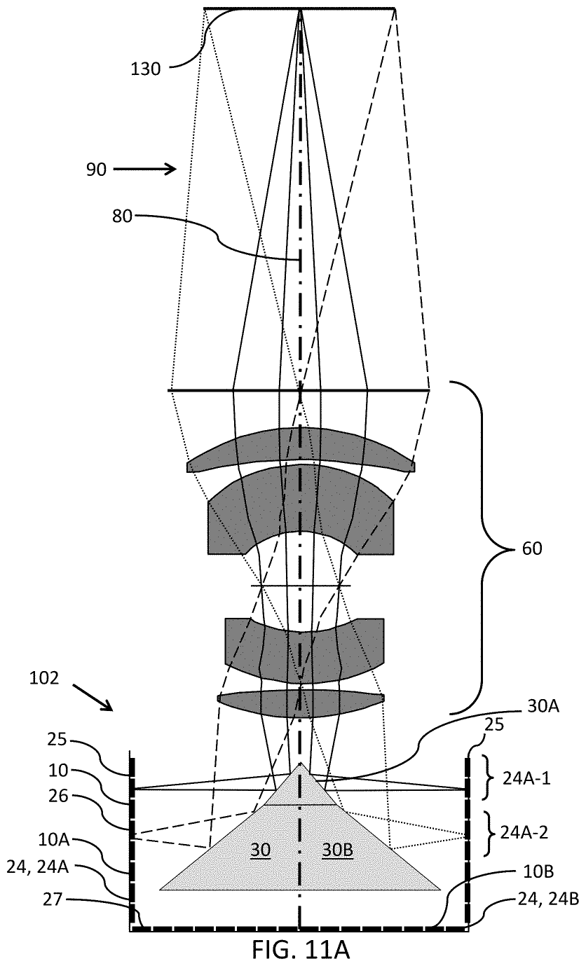

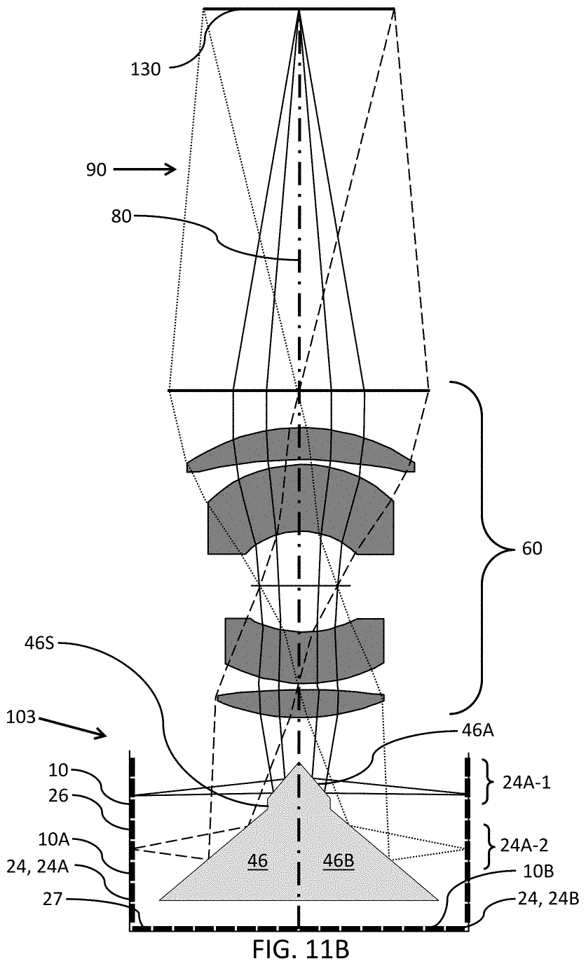

FIGS. 9A and 9B illustrate a top view and isometric view, respectively, of a conical mirror light redistribution optic 30. Light redistribution optic 30 includes two distinct angles or a “double cone” on its leading-edge surfaces 30A and 30B. The functionality and purpose of the leading-edge surfaces 30A and 30B is described in relation to FIGS. 11A, below. Light redistribution optic 30 may also be used with housing 10 illustrated in FIG. 6A to reimage light entering the sensor housing 12 onto the pixel elements 26 and 27 (e.g., side surfaces 24A and end-surface 24B). Light redistribution optic 40 may also be used with other housings.

FIGS. 9C and 9D illustrate a top view and isometric view, respectively, of a conical light redistribution optic 40. Light redistribution optic 40 may be used with housing 10 illustrated in FIG. 6A to reimage light entering the sensor housing 10 onto the pixel elements 26 and 27. Light redistribution optic 40 may also be used with other housings.

FIGS. 9E and 9F illustrate a top view and isometric view, respectively, of another conical light redistribution optic embodiment. Conical light redistribution optic with single spacer section 46 includes a spacer section 46S between surfaces 46A and 46B. The functionality and purpose of the spacer section 46S is described in relation to FIG. 11B, below. A spacer section, like spacer section 46S, may be applied on other light redistribution optics, for example, light redistribution optics 40-46.

Light redistribution optic 46 may be used with housing 10 or 12 to reimage light entering the housing 10 or 12 onto the pixel elements 26 and 27 (e.g., side-surface 10A or 12A and end-face surface 10B or dome surface 12B). Light redistribution optic 46 may also be used with other housings.

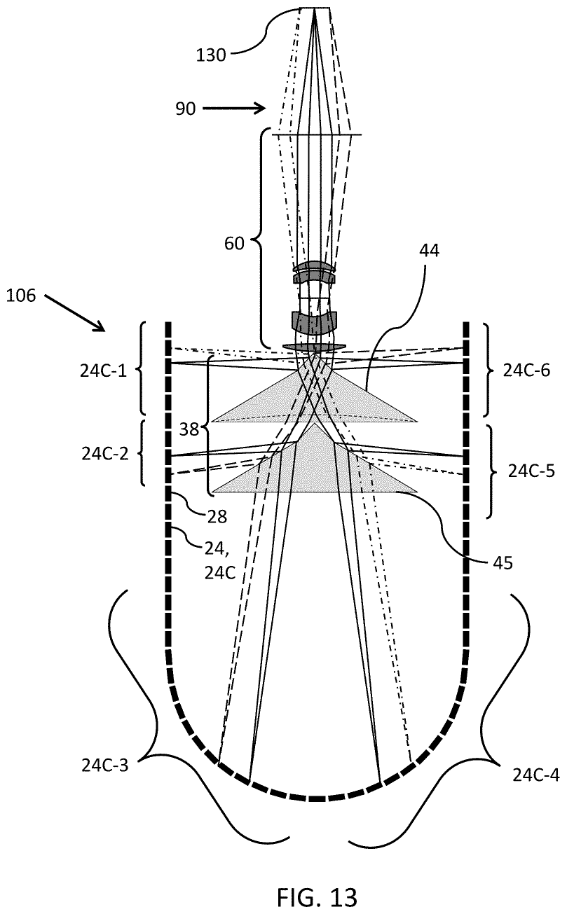

FIGS. 9G and 9H illustrate cut-away views of two additional variations of a conical light redistribution optic. Lensed conical light redistribution optic 44 includes a curved surface at its base surface 44C opposite its vertex. Non-lensed conical light redistribution optic 45 does not include a curved surface at its base surface 45C opposite its vertex. The functionality and purpose of the base surfaces 44C and 45C is described in relation to FIG. 13A, below.

Like light redistribution optic 30, light redistribution optics 44 and 45 also include two distinct angles on their leading-edge surfaces 44A, 44B, and 45A and 45B. The functionality and purpose of the leading-edge surfaces 44A, 44B, 45A, and 45B is described in relation to FIG. 11A, below. Light redistribution optics 44 and 45 may be used with housing 10 or 12 to reimage light entering the housing 10 or 12. Light redistribution optic 30 may also be used with other housings.

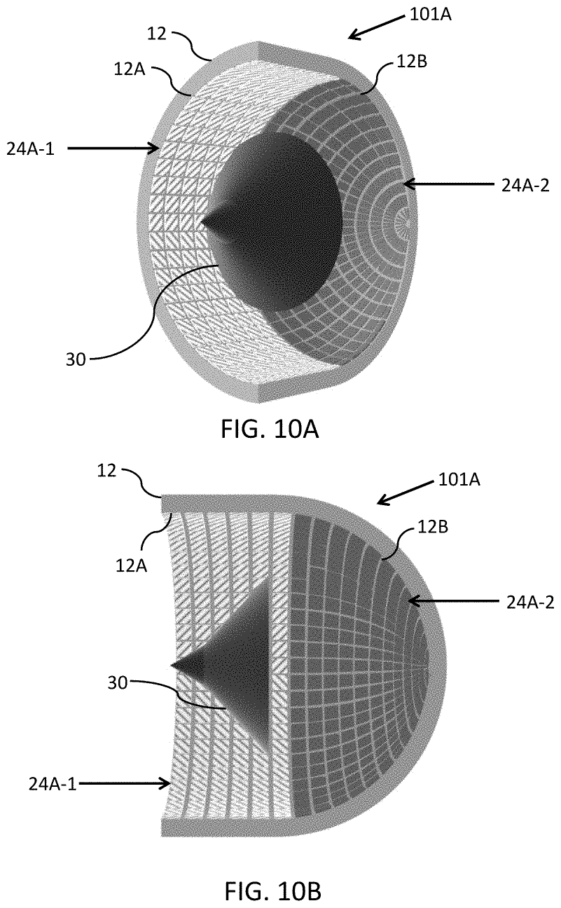

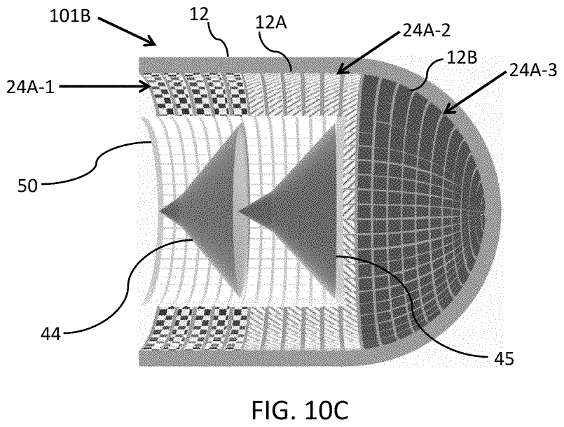

FIGS. 10A through 10C illustrate cut-away views of two embodiments of a uniaxial optical multi-measurement sensor 101A, and 101B, each with a dome sensor housing 12. Dome sensor housing 12 includes an inside cylindrical surface 12A and dome end face 12B. For uniaxial optical multi-measurement sensor 101A, shown in FIGS. 10A and 10B, cylindrical surface 12A includes sub-sensor 24A-1 and dome end face 12B includes sub-sensor 24A-2. In addition, uniaxial optical multi-measurement sensor 101A uses conical light redistribution optic 30 to direct or reimage uncollimated light entering the sensor housing (not shown) onto the pixel arrays 24A-1 and 24A-1.

Uniaxial optical multi-measurement sensor 101B, shown in FIG. 10C, includes conical light redistribution optics 44 and 45. Conical light redistribution optic 44 directs light entering the sensor housing 12 towards pixel array 24A-1; conical light redistribution optic 45 directs light entering the sensor housing 12 towards pixel arrays 24A-2 and 24A-3. Uniaxial optical multi-measurement sensor 101B also includes transmissive filter 50. Each of the pixel arrays 24A-1, 2, and 3, may image or measure different properties of light entering sensor housing 12.

FIGS. 11A-13 illustrate various light ray-tracing simulations performed using Zemax OpticStudio® version 21.3.1 (“Zemax”), created by Zemax Corporation, to validate the optical design of the various uniaxial optical multi-measurement sensor embodiments disclosed herein. The front-end optics 60 illustrated in these figures is based on the Sequential Image Simulation example “Double Gauss Experiment Arrangement”, as found in Zemax version 21.3.1. The front-end optics 60 are only one example of a lens column used to image a scene and could be replaced by other conventional camera lens systems.

FIG. 11A illustrates uncollimated light 90 originating from a scene 130, propagating through front-end optics 60 and entering a uniaxial optical multi-measurement sensor 102. Uniaxial optical multi-measurement sensor 102 includes a light redistribution optic 30 with leading-edge surfaces or “double cones” 30A and 30B. Sensor 102 also includes a housing 10 with inside surface 10A and end surface 10B. Pixel array 24A is attached to side surface 10A (with pixel elements 26) and pixel array 24B is attached to end surface 10B. Pixel array 24A has been subdivided into two groups of sub-sensors 24A-1 and 24A-2. In this embodiment, sub-sensors 24A-1 and 24A-2 are positioned on pixel array 24A in a single plane along the direction of the center axis 80 (as opposed to being portioned circumferentially as shown in FIG. 5A).

The ray tracing simulation illustrated in FIG. 11A shows that the uncollimated light 90 enters the sensor 102 or housing 10 where it reflects off the light redistribution optic 30 (e.g., surfaces 30A and 30B) and is imaged on pixel elements 26 or sub-sensors 24A-1 and 24A-2. In this embodiment, the position of sub-sensors 24A-1 and 24A-2 are aligned to image the light reflected from the different surface angles of surfaces 30A and 30B. The different angles on light redistribution optic 30, e.g., surfaces 30A and 30B, are intended to reflect light onto sub-sensors 24A-1 and 24A-2 such that both sub-sensors may be placed in a single plane that is extended into a cylindrical surface or plane, e.g., cylindrical pixel plane 25. Sub-sensors 24A-1 and 24A-2 are configured to measure or image two or more properties of light 90 entering the sensor housing 10 from a single viewpoint, for example, all along a single center axis 80. Sub-sensor 24A-1 may measure or image one property light and sub-sensor 24A-2 may measure or image a second property of light.

FIG. 11B illustrates a similar ray-trace simulation as shown in FIG. 8A, only with a different uniaxial optical multi-measurement sensor 103 having a different light redistribution optic 46. Light redistribution optic 46 is illustrated in FIGS. 9E and 9F with surfaces 46A, 46B, and spacer section 46S. In this embodiment, spacer section 46S is used to separate surfaces 46A and 46B, which each have different reflection angles relative to center axis 80. Similar to the previous embodiment of sensor 102 illustrated in FIG. 11A, the position of sub-sensors 24A-1 and 24A-2 (of sensor 103) are aligned to image the light reflected from the different surface angles of surfaces 46A and 46B. Sub-sensors 24A-1 and 24A-2 are configured to measure or image two or more properties of light 90 entering the sensor housing 10 from a single viewpoint, for example, all along a single center axis 80.

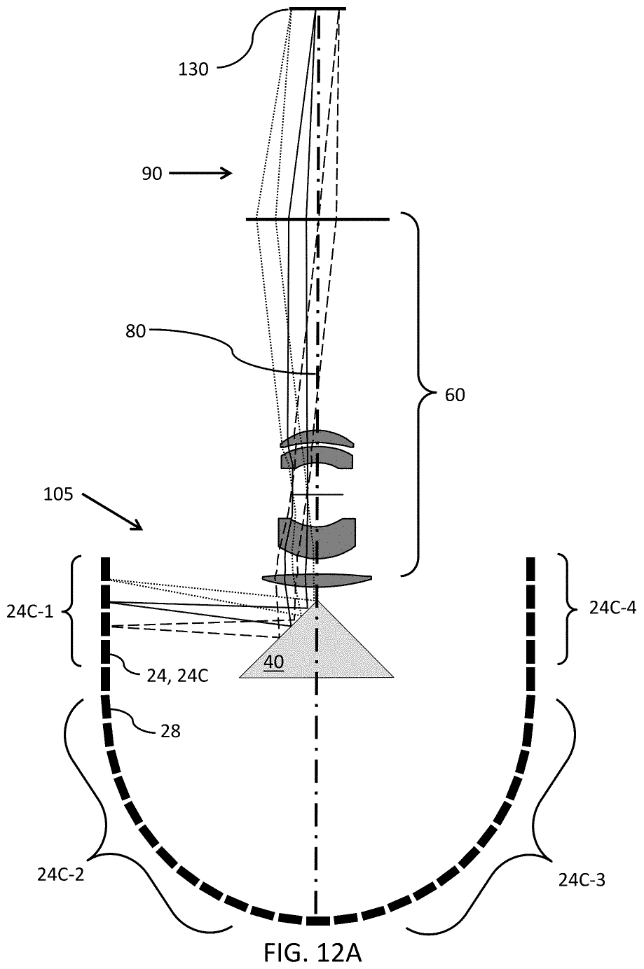

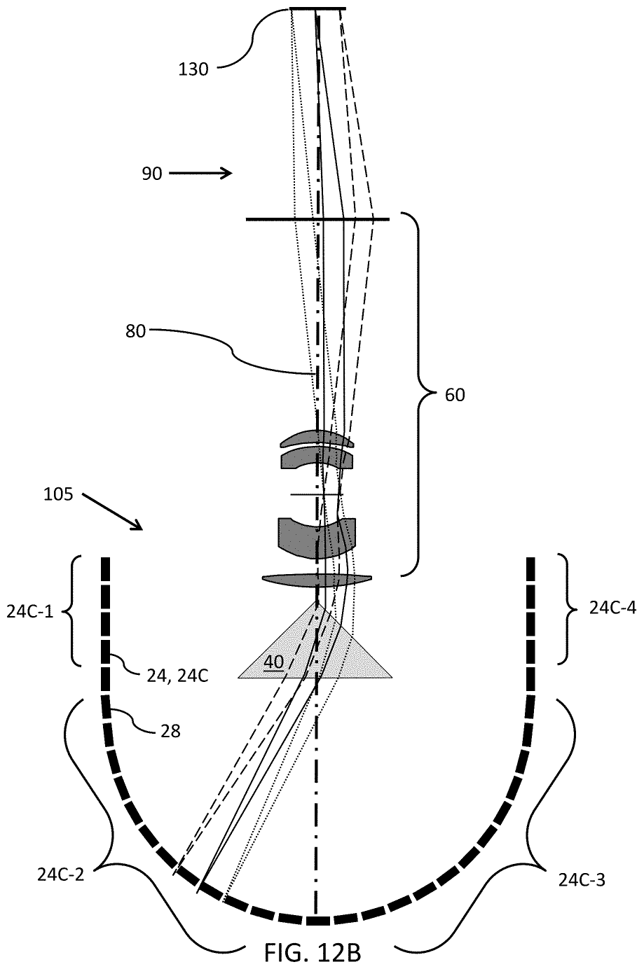

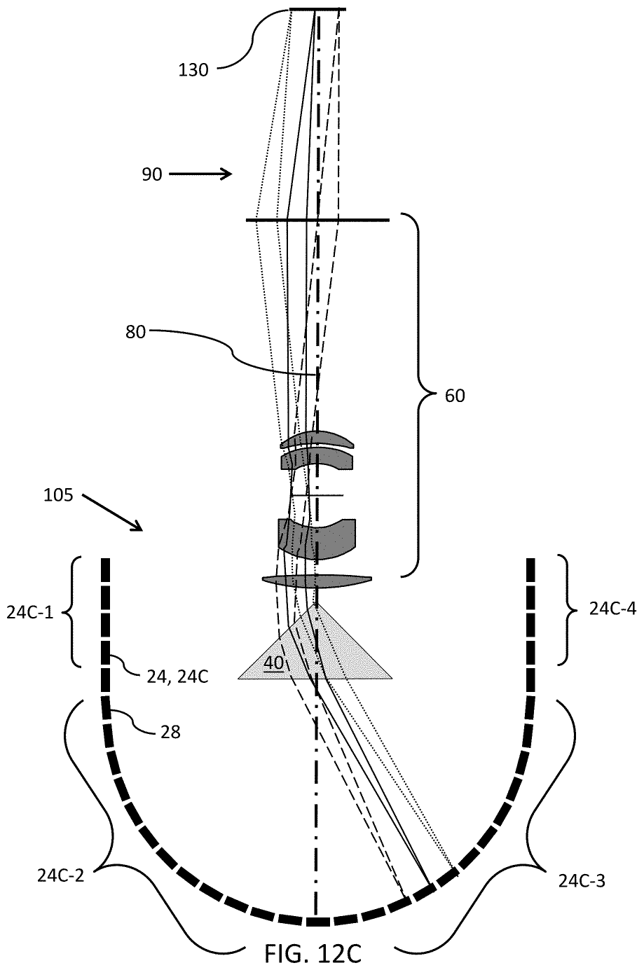

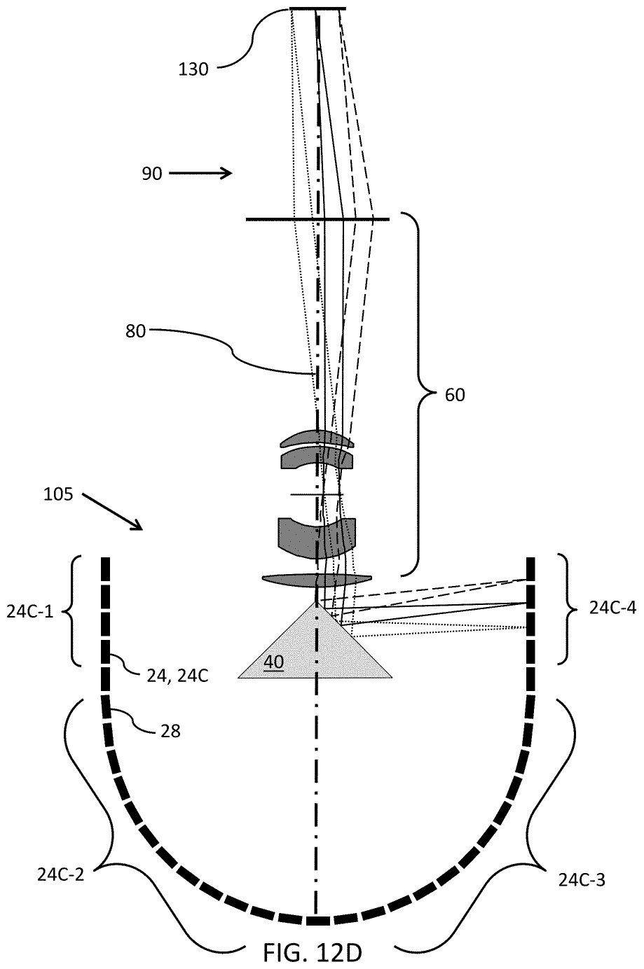

FIGS. 12A-12D illustrate ray traces through another uniaxial optical multi-measurement sensor 105. For simplicity, the housing 12 is not illustrated in these figures. Sensor 105 includes an array of electrically coupled light-sensitive pixel elements 28 in pixel array 24. Pixel array 24 may be sub-divided into multiple sub-sensor groups 24C-1 through 24C-4. In FIGS. 12A-12D, the uncollimated light 90 from the scene 130 propagates through front-end optics 60 onto light redistribution optic 40 (also shown in FIGS. 9C and 9D). In FIG. 12A, light redistribution optic 40 directs or reimages light 90 towards sub-sensor group 24C-1. In FIGS. 12B-12D, light redistribution optic 40 directs or reimages light 90 towards sub-sensor group 24C-2, 24C-3, and 24C-4, respectively. Sub-sensor groups 24C-1, 2, 3, and 4 may each measure or image a different property of the light entering the sensor 105. Additionally, sub-sensor groups 24C-1, 2, 3, and 4 each measure or image their respective property of the light from the same viewpoint.

FIG. 13 illustrates another uniaxial optical multi-measurement sensor 106. Sensor 106 includes a stacked conical-beam splitter 38 comprising a lensed conical light redistribution optic 44 and a non-lensed conical light redistribution optic 45. In this example embodiment, uncollimated light 90 propagates from a scene 130 through forward optics 60 and into the sensor 106 where it is reflected and refracted (or multiple combinations thereof) from or through light redistribution optics 44 and 45 onto pixels 28 of pixel array 24 or 24C. In this embodiment, pixel array 24-C is subdivided into sub-sensor groups 24C-1, 2, 3, 4, 5, and 6. Sub-sensor groups 24C-1, 2, 3, 4, 5, and 6 may each measure or image a different property of the light entering the sensor 106.

Also in this embodiment, lensed conical light redistribution optic 44 is placed in the light 90 path first and a non-lensed conical light redistribution optic 45 is placed in the light 90 path second. This is necessary to direct the light 90 properly through light redistribution optic 44 onto light redistribution optic 45 such that it forms an image (or is focused) on each of the sub-sensor groups 24C-1, 2, 3, 4, 5, and 6.

Sensor 106 includes two light redistribution optics 44 and 45. In other embodiments, three, four, or more light redistribution optics may be similarly stacked to direct or reimage light entering the sensor housing to additional groups of sub-sensors depending on what or how many light properties the uniaxial optical multi-measurement sensor is intended to image or measure.

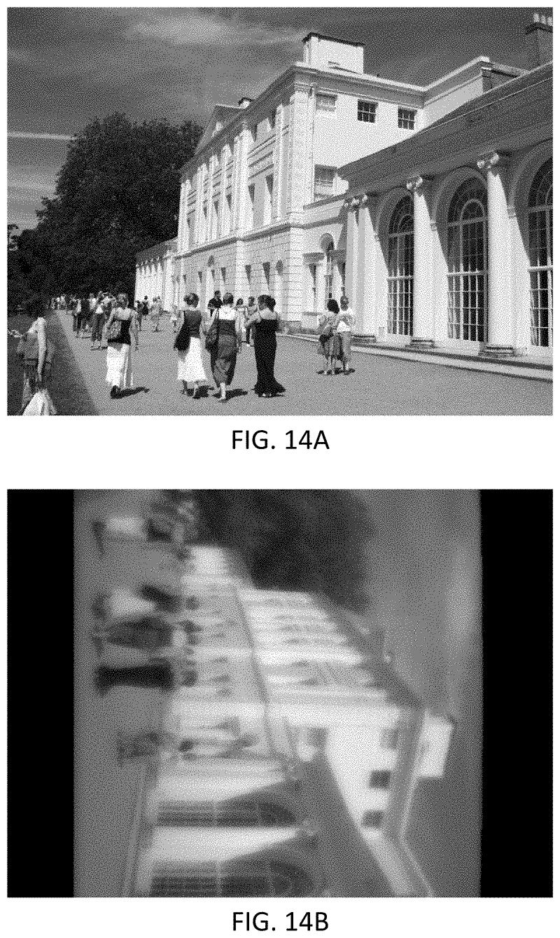

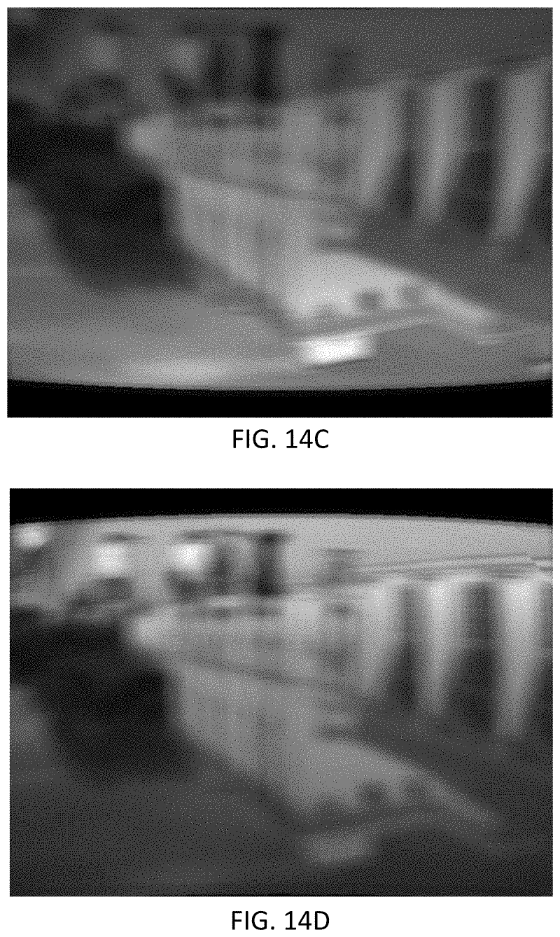

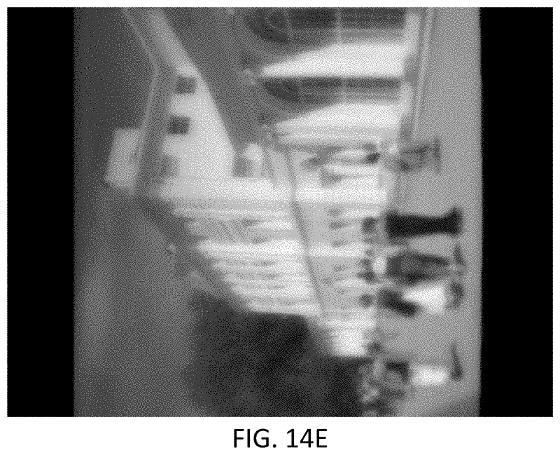

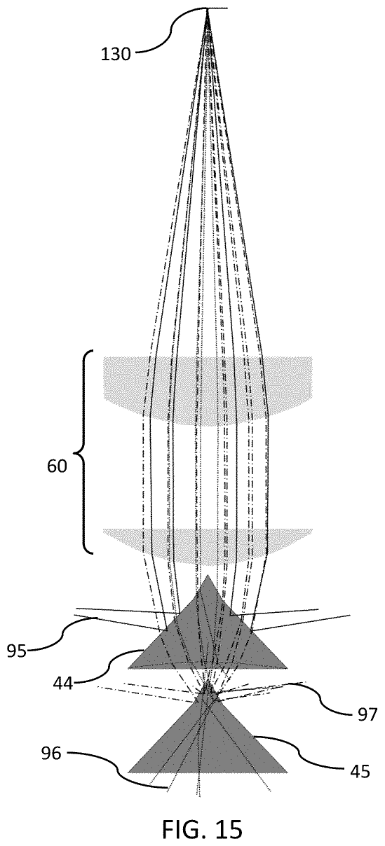

FIGS. 14A through 14E illustrate an example image from a scene that may be captured from the various embodiments of a uniaxial optical multi-measurement sensor disclosed herein. FIG. 14A is the “original” scene or image (e.g., photograph). The contents of the image are not significant, only that it represents a scene. In this example, light from a scene may include multiple properties of light, including its spectrum, intensity, polarization, and so forth. FIG. 14B is a simulated image from Zemax of the scene from FIG. 14A as captured by sub-sensor group 24C-1 of sensor 105 in FIG. 12A. Similarly, FIGS. 14C, 14D, and 14E are simulated images from Zemax of the image from 14A as captured by sub-sensor group 24C-2 in FIG. 12B, sub-sensor group 24C-3 in FIG. 12C, and sub-sensor group 24C-4 in FIG. 12D, respectively, all of sensor 105. While the images in FIGS. 14B, 14C, 14D and 14E are blurred, they are still images captured from multiple sub-sensor groups of a single scene and from a single viewpoint. The simulated ray traces in FIGS. 12A, 12B, 12C and 12D and their corresponding images in FIGS. 14B, 14C, 14D, and 14E, illustrate that multiple images may be captured from separate sub-sensor groups “viewing” a scene from a single viewpoint. The system, however, may be further optimized to provide clear images on each of the separate sub-sensor groups.

FIG. 15 illustrates another Zemax light ray-tracing simulation. In this depiction, only a portion of a uniaxial optical multi-measurement sensor is illustrated. The uniaxial optical multi-measurement sensor may be sensor 101B shown in FIG. 10C. In this illustration, light from a scene 130 includes ultraviolet light 95 (10-400 nm), visible light 96 (400-700 nm), and infrared light 97 (700+nm). The uncollimated light from the scene proceeds through front-end optics 60.

Also in this depiction, a sensor (not labeled) includes light redistribution optics 44 and 45. Lensed conical light redistribution optic 44 is placed in the light path first and non-lensed conical light redistribution optic 45 is placed in the light path second. The light enters the sensor and interacts with the light redistribution optic 44. Optic 44 is coated with a THORK08 coating. Zemax identifies several “off-the-shelf” coatings, such as those described in this description, that may be used in Zemax simulations. The THORK08 coating reflects the incident ultraviolet light 95 towards a first sub-sensor (not shown) configured to measure or image ultraviolet light. In addition, optic 44 passes the visible light 96 and infrared light 97 onto non-lensed conical light redistribution optic 45.

The visible light 96 and infrared light 97 pass through to lensed optic 44 where they interact with optic 45. Optic 45 is coated with the IR_BLOCK_45L coating (also as identified by Zemax). This coating reflects the incident infrared light towards a second sub-sensor (not shown) configured to measure or image infrared light 97. IR_BLOCK_45L coating also reflects 320-405 nm light (e.g., ultraviolet light 95), but that light was already removed by optic 44. Since the ultraviolet light 95 and infrared light 97 have been filtered, the visible light 96 passes through to a back sub-sensor (not shown). A back sub-sensor is configured to measure or image visible light 96.

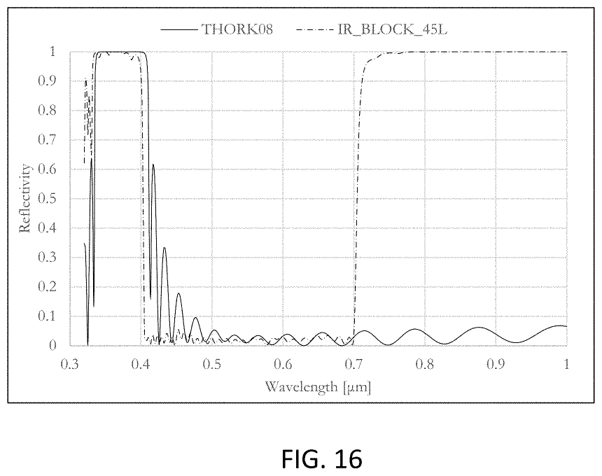

FIG. 16 illustrates the reflectivity of the THORK08 and IR_BLOCK_45L coatings as a function of light wavelength. These coatings, arranged as described above, help enable a uniaxial optical multi-measurement sensor to measure or image multiple properties of light of a scene from a single viewpoint. In addition, conical sensors, such as those disclosed herein, enable the light to be directed towards a large area of multiple sub-sensors positioned on different portions of a cylindrical surface such that multiple properties of the light may be measured or imaged by the uniaxial optical multi-measurement sensor.

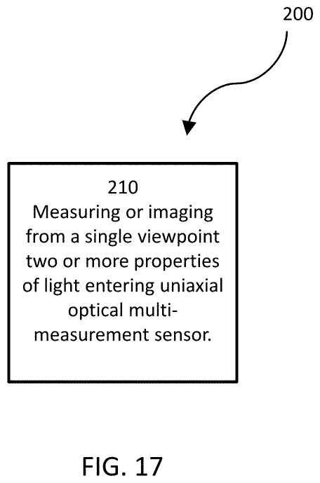

FIG. 17 illustrates a method 200 for measuring light properties. Method 200 includes the step 210 of measuring or imaging from a single viewpoint two or more properties of light entering a sensor system (e.g., sensor system 100, 102, 103, 104, 105, or 106). The sensor system comprises a sensor housing having a center axis and an inside surface that is a cylindrical surface or an end face. The sensor system further comprises an array of electrically coupled light-sensitive pixel elements attached to one or more of the cylindrical surface or the end face. In the sensor system, each pixel element is positioned having its light-sensitive side facing towards or along the center axis. The sensor system further comprises a light redistribution optic positioned along the center axis to direct or reimage the light entering the sensor system onto the pixel elements. Also, within the sensor system, the pixel elements are positioned relative to the light redistribution optic to measure or image the two or more properties of the light entering the sensor system from the single viewpoint.

The present invention may be embodied in other specific forms without departing from its spirit or essential characteristics. The described embodiments are to be considered in all respects only as illustrative, and not restrictive. All changes which come within the meaning and range of equivalency of the foregoing description are to be embraced within the scope of the invention.

It will be appreciated that several of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art and are also intended to be encompassed by the following claims.

I claim:

1. A uniaxial optical multi-measurement sensor, comprising:
a sensor housing having a center axis and a cylindrical surface;
an array of electrically coupled light-sensitive pixel elements attached to the cylindrical surface, wherein each pixel element is positioned having its light-sensitive side facing towards the center axis; and
a conical light redistribution optic positioned along the center axis to direct or reimage uncollimated light entering the sensor housing onto the pixel elements; wherein
the pixel elements are positioned relative to the light redistribution optic to measure or image two or more properties of the uncollimated light entering the sensor housing of a single scene and from a single viewpoint.

2. The sensor of claim 1, further comprising an end surface at the end of the sensor housing and a second array of electrically coupled light-sensitive pixel elements attached to the end surface.

3. The sensor of claim 2, wherein the uncollimated light entering the sensor housing is:
reflected from the conical light redistribution optic to the array of electrically coupled light-sensitive pixel elements attached to the cylindrical surface; and
transmitted through the conical light redistribution optic towards the second array of pixel elements attached to the end surface.

4. The sensor of claim 2, wherein the end surface at the end of the sensor housing is a hemispherical dome.

5. The sensor of claim 1, wherein the conical light redistribution optic further comprises a first outside surface defined by a first angle relative to the center axis and a second outside surface defined by a second angle relative to the center axis, the second angle being different than the first angle.

6. The sensor of claim 1, wherein the conical light redistribution optic further comprises a spacer section that separates, in a direction along the center axis, portions of the conical light redistribution optic outside surface to form two or more light redistribution optic sections.

7. The sensor of claim 1, wherein the conical light redistribution optic is a conical beam splitter.

8. The sensor of claim 1, wherein the conical light redistribution optic is two or more conical light redistribution optics stacked along the center axis to direct or reimage the uncollimated light entering the sensor housing onto the pixel elements.

9. The sensor of claim 8, wherein one of the two or more conical light redistribution optics stacked along the center axis is a lensed conical light redistribution optic and the other of the two or more light redistribution optics stacked along the center axis is a non-lensed conical light redistribution optic.

10. The sensor of claim 1, further comprising a transmissive filter positioned between the pixel elements and the light redistribution optic, the transmissive filter comprising a filter array having one or more individual filter elements, each filter element having one or more filters.

11. A method for measuring light properties, the method comprising:
measuring or imaging from a single viewpoint two or more properties of light entering a uniaxial optical multi-measurement sensor from a single scene, the sensor comprising:
a sensor housing having a center axis and a cylindrical surface;
an array of electrically coupled light-sensitive pixel elements attached to the cylindrical surface, wherein each pixel element is positioned having its light-sensitive side facing towards the center axis; and
a conical light redistribution optic positioned along the center axis to direct or reimage uncollimated light entering the sensor housing onto the pixel elements; wherein
the pixel elements are positioned relative to the light redistribution optic to measure or image the two or more properties of the uncollimated light.

12. The method of claim 11, wherein the sensor further comprises an end surface at the end of the sensor housing and a second array of electrically coupled light-sensitive pixel elements attached to the end surface.

13. The method of claim 12, wherein the uncollimated light entering the sensor housing is:
reflected from the conical light redistribution optic to the array of electrically coupled light-sensitive pixel elements attached to the cylindrical surface; and
transmitted through the conical light redistribution optic towards the second array of pixel elements attached to the end surface.

14. The method of claim 12, wherein the end surface at the end of the sensor housing is a hemispherical dome.

15. The method of claim 11, wherein the conical light redistribution optic further comprises a first outside surface defined by a first angle relative to the center axis and a second outside surface defined by a second angle relative to the center axis, the second angle being different than the first angle.

16. The method of claim 11, wherein the conical light redistribution optic further comprises a spacer section that separates, in a direction along the center axis, portions of the conical light redistribution optic outside surface to form two or more light redistribution optic sections.

17. The method of claim 11, wherein the conical light redistribution optic is a conical beam splitter.

18. The method of claim 11, wherein the conical light redistribution optic is two or more conical light redistribution optics stacked along the center axis to direct or reimage the uncollimated light entering the sensor housing onto the pixel elements.

19. The method of claim 11, wherein one of the two or more conical light redistribution optics stacked along the center axis is a lensed conical light redistribution optic and the other of the two or more light redistribution optics stacked along the center axis is a non-lensed conical light redistribution optic.

20. A uniaxial optical multi-measurement sensor, comprising:
a sensor housing having a center axis, a cylindrical surface, and a hemispherical-dome end surface;
a first array of electrically coupled light-sensitive pixel elements attached to the cylindrical surface and a second array of electrically coupled light-sensitive pixel elements attached to the hemispherical dome end surface, wherein each pixel element of the first and second array is positioned having its light-sensitive side facing towards or along the center axis;
a lensed conical light redistribution optic positioned along the center axis to direct or reimage uncollimated light entering the sensor housing onto the first array of electrically coupled light-sensitive pixel elements;
a non-lensed conical light redistribution optic positioned along the center axis to direct or reimage the uncollimated light from the lensed conical light redistribution optic onto the second array of electrically coupled light-sensitive pixel elements; wherein
the pixel elements are positioned relative to the light redistribution optic to measure or image two or more properties of the uncollimated light.
